(19) United States
(12) Patent Application Publication
(10) Pub. No.: US 2026/0332274 A1
(43) Pub. Date: Oct. 22, 2026

(54) LIGHTING DEVICE HAVING TIME CALIBRATION FUNCTION AND LIGHTING SYSTEM HAVING THE SAME

(71) Applicant: Xiamen PVTECH Co., Ltd., Xiamen (CN)

(72) Inventors: WEIPING LIN, Xiamen (CN); ZHIRONG LIN, Xiamen (CN); CHENGQUAN XU, Xiamen (CN); FUXING LU, Xiamen (CN)

(21) Appl. No.: 19/645,358

(22) Filed: Apr. 13, 2026

(30) Foreign Application Priority Data
Apr. 16, 2025 (CN) 202510478035.4

(51) Int. Cl. H04B 17/21

(52) U.S. Cl. CPC H04B 17/22

(57) ABSTRACT

The lighting device having a time calibration function and the lighting system having the same are provided. The lighting device includes a processing module, a timing module and a first radio frequency signal module. The timing module is connected to the processing module. The first radio frequency signal module is connected to the processing module. The processing module receives a local time signal through the first radio frequency signal module, and calibrate the current time of the timing module according to the local time signal so as to update the current time of the timing module.

### TECHNICAL FIELD

The disclosure relates to a lighting device, in particular to a lighting device having a time calibration function. The disclosure further relates to the lighting system having the lighting device.

### BACKGROUND

With the advancement of technology, the performance of lighting devices has been significantly improved. However, currently available lighting devices still have several drawbacks that require further improvement.

For example, currently available lighting devices lack a time synchronization mechanism. As a result, time calibration and other parameter configurations must be performed manually, which significantly increases the overall cost of the lighting system.

In addition, some currently available lighting devices are equipped with a real-time clock (RTC) chip, but these lighting devices may still experience time drift after long-term operation.

Furthermore, when such lighting devices are deployed across different time zones or countries, time configuration issues such as time zone conversion and daylight saving time adjustments often cause serious problems.

### SUMMARY

One embodiment of the disclosure provides a lighting device having a time calibration function, which includes a processing module, a timing module and a first radio frequency signal module. The timing module is connected to the processing module. The first radio frequency signal module is connected to the processing module. The processing module receives a local time signal through the first radio frequency signal module, and calibrates the current time of the timing module according to the local time signal so as to update the current time of the timing module.

Another embodiment of the disclosure further provides a lighting system having a time calibration function, which includes an information publishing device and a lighting device. The information publishing device receives a local time signal. The lighting device includes a processing module, a timing module, and a first radio frequency signal module. The timing module and the first radio frequency signal module are connected to the processing module. The processing module receives the local time signal through the first radio frequency signal module and calibrates the current time of the timing module according to the local time signal so as to update the current time of the timing module.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a block diagram of a lighting system having a time calibration function in accordance with one embodiment of the disclosure.

FIG. 2 is a block diagram of a lighting device having a time calibration function in accordance with one embodiment of the disclosure.

FIG. 3 is a block diagram of an information publishing device of the lighting system having the time calibration function in accordance with one embodiment of the disclosure.

FIG. 4 is a schematic diagram illustrating a delay calibration mechanism of a calibration delay window of the lighting device having the time calibration function in accordance with one embodiment of the disclosure.

FIG. 5 is a flow chart of a time calibration method for a lighting device in accordance with one embodiment of the disclosure.

FIG. 6 is a block diagram of an information publishing device of a lighting system having a time calibration function in accordance with another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

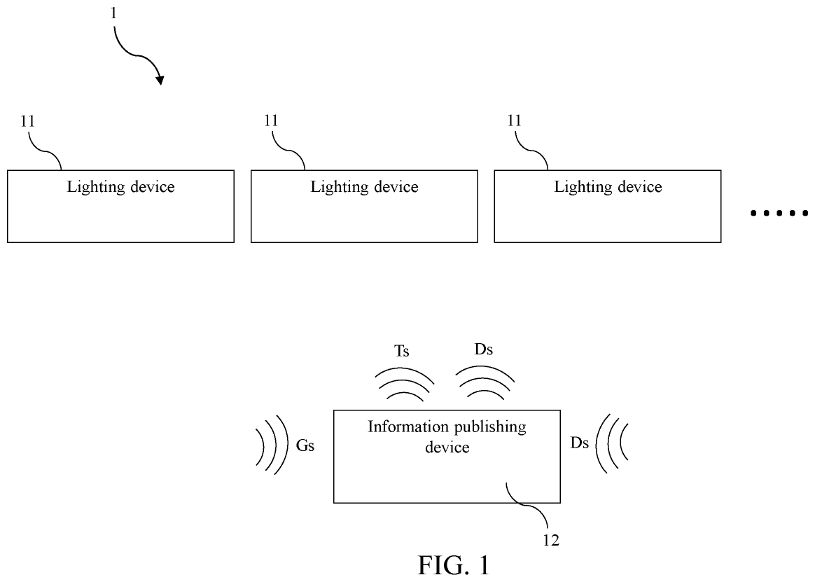

Please refer to FIG. 1, which is a block diagram of a lighting system having a time calibration function in accordance with one embodiment of the disclosure. As shown in FIG. 1, the lighting system 1 includes a plurality of lighting devices 11 and an information publishing device 12. These lighting devices 11 may be evenly distributed in a predetermined area (such as a building). The lighting system 1 may include only one lighting device 11, or two or more lighting devices 11 (FIG. 1 illustrates only three lighting devices).

The embodiment just exemplifies the disclosure and is not intended to limit the scope of the disclosure; any equivalent modification and variation according to the spirit of the disclosure is to be also included within the scope of the following claims and their equivalents.

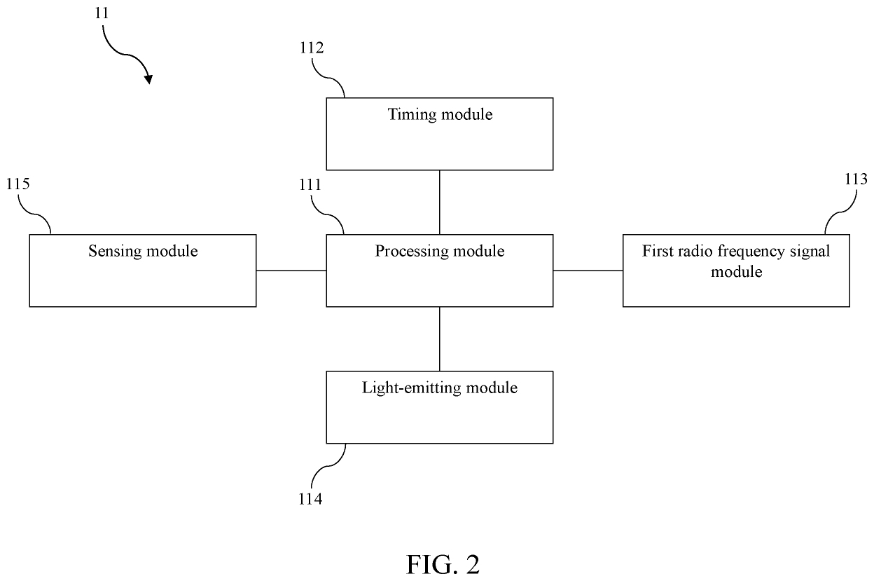

Please refer to FIG. 2, which is a block diagram of a lighting device having a time calibration function in accordance with one embodiment of the disclosure. As shown in FIG. 2, each lighting device 11 includes a processing module 111, a timing module 112, a first radio frequency signal module 113, a light-emitting module 114, and a sensing module 115. The timing module 112, the first radio frequency signal module 113, the light-emitting module 114, and the sensing module 115 are connected to the processing module 111.

In one embodiment, the processing module 111 may be a microcontroller (MCU), a central processing unit (CPU), an application-specific integrated circuit chip (ASIC), a field programmable gate array (FPGA), or other similar components.

In one embodiment, the timing module 112 may be a real-time clock (RTC) chip or other components having a timing function.

In one embodiment, the first radio frequency signal module 113 may be a radio frequency signal antenna or other circuits having radio frequency signal transmitting and receiving capability.

In one embodiment, the light-emitting module 114 may be a light-emitting diode (LED), a bulb, a fluorescent lamp, or other similar components.

In one embodiment, the sensing module 115 may be a microwave sensor, an infrared sensor, or other similar components.

The embodiment just exemplifies the disclosure and is not intended to limit the scope of the disclosure; any equivalent modification and variation according to the spirit of the disclosure is to be also included within the scope of the following claims and their equivalents.

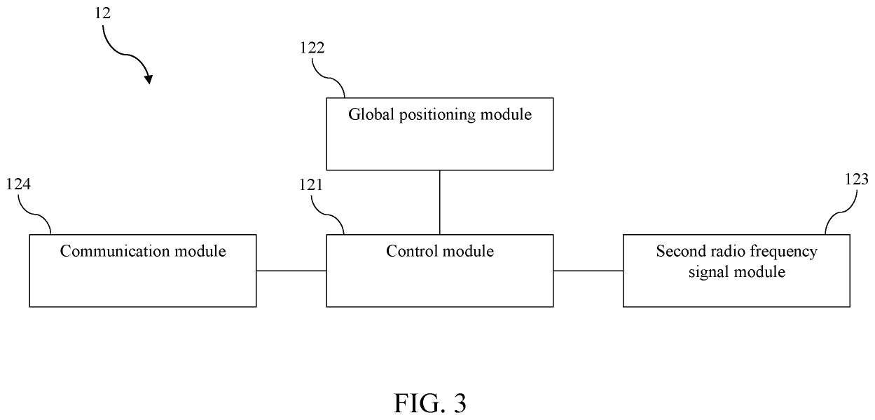

Please refer to FIG. 3, which is a block diagram of an information publishing device of the lighting system having the time calibration function in accordance with one embodiment of the disclosure. As shown in FIG. 3, the information publishing device 12 includes a global positioning module 122, a control module 121, a second radio frequency signal module 123, and a communication module 124.

In one embodiment, the control module 121 may be a microcontroller (MCU), a central processing unit (CPU), an application-specific integrated circuit chip (ASIC), a field programmable gate array (FPGA), or other similar components.

In one embodiment, the global positioning module 122 may be a GPS module or other existing satellite positioning modules.

In one embodiment, the second radio frequency signal module 123 may be a radio frequency signal antenna or other circuits having radio frequency signal transmitting and receiving capability.

In one embodiment, the communication module 124 may be a Bluetooth module, a WiFi module, a Zigbee module, or other similar components.

As shown in FIG. 1, FIG. 2, and FIG. 3, the global positioning module 122 of the information publishing device 12 receives a global positioning signal Gs. The control module 121 of the information publishing device 12 generates a local time signal Ts according to the global positioning signal Gs and transmits the local time signal Ts to the first radio frequency signal module 113 of the lighting device 11 through the second radio frequency signal module 123.

The processing module 111 of the lighting device 11 receives the local time signal Ts through the first radio frequency signal module 113 and calibrates the current time of the timing module 112 according to the local time signal Ts so as to update the current time of the timing module 112.

Through the above time synchronization mechanism, these lighting devices 11 can effectively achieve time synchronization so that the time settings of these lighting devices 11 can always remain accurate. Accordingly, even after long-term operation, these lighting devices 11 will not generate time errors in order to conform to actual requirements.

In addition, the information publishing device 12 can simultaneously perform time management for these lighting devices 11 so that these lighting devices 11 can effectively achieve time synchronization. As a result, the time settings of these lighting devices 11 can always remain accurate. Therefore, the overall cost of the lighting system 1 can be significantly reduced so as to satisfy the requirements of different applications.

The control module 121 of the information publishing device 12 may receive a lighting configuration signal Ds through the communication module 124 of the information publishing device 12 and transmit the lighting configuration signal Ds to the first radio frequency signal module 113 of the lighting device 11. The processing module 111 of the lighting device 11 receives the lighting configuration signal Ds through the first radio frequency signal module 113 of the lighting device 11 and controls the light-emitting module 114 of the lighting device 11 according to the lighting configuration signal Ds.

Accordingly, the user may perform lighting configuration settings (such as group settings, brightness settings, and color temperature settings) through an electronic device (such as a smartphone, a tablet computer, or a notebook computer), and transmit the corresponding lighting configuration signal Ds through the communication module of the electronic device (such as a Bluetooth module) to the information publishing device 12 so that the lighting configuration signal Ds is transmitted to all lighting devices 11 in order to achieve a desired lighting effect. Therefore, the lighting system 1 can be more convenient in use and more flexible in application.

In addition, the communication module 124 of the information publishing device 12 may also be used to receive the local time signal Ts.

The sensing module 115 of the lighting device 11 may detect a moving object (such as a person or a vehicle) to generate a sensing signal. The processing module 111 of the lighting device 11 may activate the light-emitting module 114 according to the sensing signal so as to achieve an automatic lighting function.

The embodiment just exemplifies the disclosure and is not intended to limit the scope of the disclosure; any equivalent modification and variation according to the spirit of the disclosure is to be also included within the scope of the following claims and their equivalents.

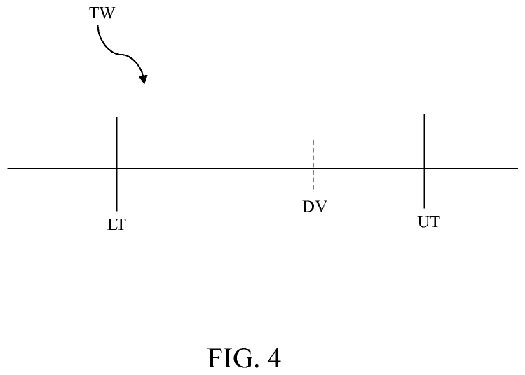

Please refer to FIG. 4, which is a schematic diagram illustrating a delay calibration mechanism of a calibration delay window of the lighting device having the time calibration function in accordance with one embodiment of the disclosure. As shown in FIG. 4, the lighting device 11 further includes a delay calibration mechanism based on calibration delay window. The processing module 111 of the lighting device 11 receives the local time signal Ts through the first radio frequency signal module 113 of the lighting device 11 and determines whether the difference between the local time signal Ts and the current time of the timing module 112 is within the calibration delay window TW.

If the processing module 111 of the lighting device 11 determines that the difference DV between the local time signal Ts and the current time of the timing module 112 is within the calibration delay window TW, the processing module 111 delays calibration of the current time of the timing module 112 according to a default delay time. In other words, the processing module 111 temporarily does not calibrate the current time of the timing module 112, but automatically performs calibration of the current time of the timing module 112 after the preset delay time has elapsed. The processing module 111 records the local time signal Ts and performs timing until the preset delay time has elapsed, and then automatically calibrates the current time of the timing module 112 according to the preset delay time and the local time signal Ts.

If the processing module 111 determines that the difference DV between the local time signal and the current time of the timing module 112 is higher than the upper limit UT of the calibration delay window TW, the processing module 111 calibrates the current time of the timing module 112.

Conversely, if the processing module 111 determines that the difference DV between the local time signal Ts and the current time of the timing module 112 is lower than the lower limit LT of the calibration delay window TW, the processing module 111 does not calibrate the current time of the timing module 112.

For example, the calibration delay window TW may be three to eight seconds. Accordingly, the upper limit UT of the calibration delay window TW is eight and the lower limit LT is three. The preset delay time may be twenty-four hours. If the difference DV is between three seconds and eight seconds, the processing module 111 records the local time signal Ts and performs timing, and after twenty-four hours calibrates the current time of the timing module 112 (by adding twenty-four hours to the time of the local time signal Ts and updating the current time of the timing module 112). If the difference DV is two seconds (which is lower than the lower limit LT of the calibration delay window TW), the processing module 111 does not calibrate the current time of the timing module 112. If the difference DV is ten seconds (which is higher than the upper limit UT of the calibration delay window TW), the processing module 111 immediately calibrates the current time of the timing module 112. The calibration delay window TW, the upper limit UT, and the lower limit LT are only examples, and the user can adjust them according to actual sensitivity requirements. The disclosure is not limited thereto.

Through the above calibration delay window delay calibration mechanism, the lighting device 11 does not need to frequently perform time calibration, thereby further reducing energy consumption of the lighting device 11.

The embodiment just exemplifies the disclosure and is not intended to limit the scope of the disclosure; any equivalent modification and variation according to the spirit of the disclosure is to be also included within the scope of the following claims and their equivalents.

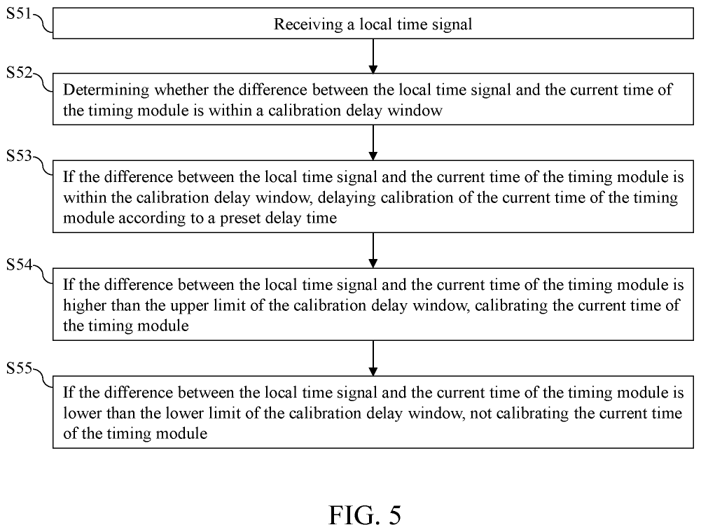

Please refer to FIG. 5, which is a flow chart of a time calibration method for a lighting device in accordance with one embodiment of the disclosure. As shown in FIG. 5, the method of this embodiment includes the following steps.

Step S51: receiving a local time signal.

Step S52: determining whether the difference between the local time signal and the current time of the timing module is within a calibration delay window.

Step S53: if the difference between the local time signal and the current time of the timing module is within the calibration delay window, delaying calibration of the current time of the timing module according to a preset delay time.

Step S54: if the difference between the local time signal and the current time of the timing module is higher than the upper limit of the calibration delay window, calibrating the current time of the timing module.

Step S55: if the difference between the local time signal and the current time of the timing module is lower than the lower limit of the calibration delay window, not calibrating the current time of the timing module.

The embodiment just exemplifies the disclosure and is not intended to limit the scope of the disclosure; any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It is worthy to point out that currently available lighting devices lack a time synchronization mechanism. As a result, time calibration and other parameter configurations must be performed manually, which significantly increases the overall cost of the lighting system. In addition, some currently available lighting devices are equipped with a real-time clock (RTC) chip, but these lighting devices may still experience time drift after long-term operation. Furthermore, when such lighting devices are deployed across different time zones or countries, time configuration issues such as time zone conversion and daylight saving time adjustments often cause serious problems. By contrast, according to one embodiment of the disclosure, a lighting device includes a processing module, a timing module and a first radio frequency signal module. The timing module is connected to the processing module. The first radio frequency signal module is connected to the processing module. The processing module receives a local time signal through the first radio frequency signal module, and calibrates the current time of the timing module according to the local time signal so as to update the current time of the timing module. As set forth above, the lighting device has a time synchronization mechanism in order to effectively achieve time synchronization, so the time setting of the lighting device can always remain accurate. Accordingly, even after long-term operation, the lighting device will not generate time errors, so the lighting device can meet actual requirements.

Also, according to one embodiment of the disclosure, the lighting system not only includes a plurality of lighting devices but also includes an information publishing device. Each lighting device integrates a radio frequency signal module. The information publishing device can simultaneously perform time management for these lighting devices, so these lighting devices can effectively achieve time synchronization. As a result, the time settings of these lighting devices can always remain accurate. Accordingly, the overall cost of the lighting system can be significantly reduced so as to satisfy the requirements of different applications.

Further, according to one embodiment of the disclosure, the lighting system includes the information publishing device, which can simultaneously perform time management for these lighting devices. Therefore, even when the lighting system is deployed across different time zones or across different countries, time configuration issues such as time zone conversion and daylight saving time adjustment can be easily completed. Accordingly, the lighting system can be more convenient in use and more flexible in application.

Moreover, according to one embodiment of the disclosure, the processing module of the lighting device can receive the local time signal through the first radio frequency signal module and determine whether the difference between the local time signal and the current time of the timing module is within the calibration delay window. When the difference between the local time signal and the current time of the timing module is within the calibration delay window, the processing module delays calibration of the current time of the timing module according to a preset delay time. When the difference between the local time signal and the current time of the timing module is higher than an upper limit of the calibration delay window, the processing module calibrates the current time of the timing module. When the difference between the local time signal and the current time of the timing module is lower than a lower limit of the calibration delay window, the processing module does not calibrate the current time of the timing module. Through the above delay calibration mechanism based on calibration delay window, the lighting device does not need to frequently perform time calibration, which can further reduce the energy consumption of the lighting device.

Furthermore, according to one embodiment of the disclosure, the processing module of the lighting device receives a lighting configuration signal through the first radio frequency signal module and controls the light-emitting module according to the lighting configuration signal. Therefore, the user may perform lighting configuration settings (such as group settings, brightness settings, color temperature settings, and the like) through an electronic device, and transmit corresponding lighting configuration signals to all lighting devices through the information publishing device so as to achieve desired lighting effects. Accordingly, the lighting system can be more convenient in use and more flexible in application. As described above, the lighting device and the lighting system according to the embodiments of the disclosure can definitely achieve great technical effects.

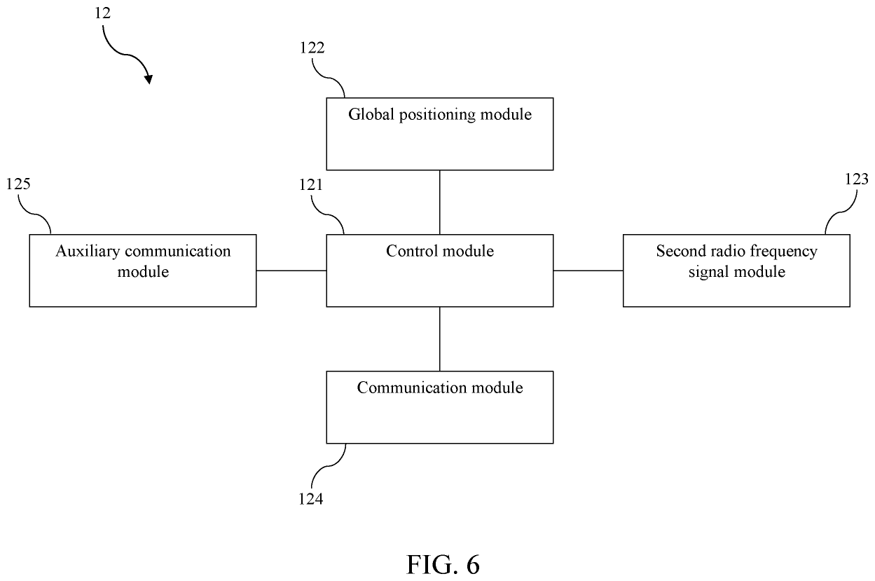

Please refer to FIG. 6, which is a block diagram of an information publishing device of a lighting system having a time calibration function in accordance with another embodiment of the disclosure. As shown in FIG. 6, the information publishing device 12 includes a global positioning module 122, a control module 121, a second radio frequency signal module 123, and a communication module 124.

The difference between this embodiment and the previous embodiment is that the information publishing device 12 further includes an auxiliary communication module 125. The communication protocol of the auxiliary communication module 125 is different from the communication protocol of the communication module 124. In one embodiment, the auxiliary communication module 125 may be a CAT1 module, a WiFi module, a Zigbee module, or other similar components.

The control module 121 of the information publishing device 12 may receive a lighting configuration signal Ds through the auxiliary communication module 125 of the information publishing device 12, and transmit the lighting configuration signal Ds to the first radio frequency signal module 113 of the lighting device 11. The processing module 111 of the lighting device 11 receives the lighting configuration signal Ds through the first radio frequency signal module 113 of the lighting device 11 and controls the light-emitting module 114 of the lighting device 11 according to the lighting configuration signal Ds.

Accordingly, the user may perform lighting configuration settings (such as group settings, brightness settings, and color temperature settings) through an electronic device (such as a smartphone, a tablet computer, or a notebook computer), and transmit the corresponding lighting configuration signal Ds through a communication module of the electronic device such as a CAT1 module to the information publishing device 12 so that the lighting configuration signal Ds is transmitted to all lighting devices 11 in order to achieve a desired lighting effect.

In addition, the auxiliary communication module 125 of the information publishing device 12 may also be used to receive the local time signal Ts.

The embodiment just exemplifies the disclosure and is not intended to limit the scope of the disclosure; any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the disclosure, a lighting device includes a processing module, a timing module and a first radio frequency signal module. The timing module is connected to the processing module. The first radio frequency signal module is connected to the processing module. The processing module receives a local time signal through the first radio frequency signal module, and calibrates the current time of the timing module according to the local time signal so as to update the current time of the timing module. As set forth above, the lighting device has a time synchronization mechanism in order to effectively achieve time synchronization, so the time setting of the lighting device can always remain accurate. Accordingly, even after long-term operation, the lighting device will not generate time errors, so the lighting device can meet actual requirements.

Also, according to one embodiment of the disclosure, the lighting system not only includes a plurality of lighting devices but also includes an information publishing device. Each lighting device integrates a radio frequency signal module. The information publishing device can simultaneously perform time management for these lighting devices, so these lighting devices can effectively achieve time synchronization. As a result, the time settings of these lighting devices can always remain accurate. Accordingly, the overall cost of the lighting system can be significantly reduced so as to satisfy the requirements of different applications.

Further, according to one embodiment of the disclosure, the lighting system includes the information publishing device, which can simultaneously perform time management for these lighting devices. Therefore, even when the lighting system is deployed across different time zones or across different countries, time configuration issues such as time zone conversion and daylight saving time adjustment can be easily completed. Accordingly, the lighting system can be more convenient in use and more flexible in application.

Moreover, according to one embodiment of the disclosure, the processing module of the lighting device can receive the local time signal through the first radio frequency signal module and determine whether the difference between the local time signal and the current time of the timing module is within the calibration delay window. When the difference between the local time signal and the current time of the timing module is within the calibration delay window, the processing module delays calibration of the current time of the timing module according to a preset delay time. When the difference between the local time signal and the current time of the timing module is higher than an upper limit of the calibration delay window, the processing module calibrates the current time of the timing module. When the difference between the local time signal and the current time of the timing module is lower than a lower limit of the calibration delay window, the processing module does not calibrate the current time of the timing module. Through the above delay calibration mechanism based on calibration delay window, the lighting device does not need to frequently perform time calibration, which can further reduce the energy consumption of the lighting device.

Furthermore, according to one embodiment of the disclosure, the processing module of the lighting device receives a lighting configuration signal through the first radio frequency signal module and controls the light-emitting module according to the lighting configuration signal. Therefore, the user may perform lighting configuration settings (such as group settings, brightness settings, color temperature settings, and the like) through an electronic device, and transmit corresponding lighting configuration signals to all lighting devices through the information publishing device so as to achieve desired lighting effects. Accordingly, the lighting system can be more convenient in use and more flexible in application.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. A lighting device having a time calibration function, comprising:
a processing module;
a timing module connected to the processing module; and
a first radio frequency signal module connected to the processing module;
wherein the processing module is configured to receive a local time signal through the first radio frequency signal module, and calibrate a current time of the timing module according to the local time signal so as to update the current time of the timing module.

2. The lighting device as claimed in claim 1, wherein the processing module is configured to receive the local time signal through the first radio frequency signal module and determine whether a difference between the local time signal and the current time of the timing module is within a calibration delay window, and wherein the processing module is configured to delay a calibration of the current time of the timing module according to a preset delay time when the difference between the local time signal and the current time of the timing module is within the calibration delay window.

3. The lighting device as claimed in claim 2, wherein the processing module is configured to calibrate the current time of the timing module when the difference between the local time signal and the current time of the timing module is higher than an upper limit of the calibration delay window, and wherein the processing module is configured not to calibrate the current time of the timing module when the difference between the local time signal and the current time of the timing module is lower than a lower limit of the calibration delay window.

4. The lighting device as claimed in claim 1, further comprising a light-emitting module connected to the processing module, wherein the processing module is configured to receive a lighting configuration signal through the first radio frequency signal module and control the light-emitting module according to the lighting configuration signal.

5. A lighting system having a time calibration function, comprising:
an information publishing device configured to receive a local time signal; and
a lighting device comprising a processing module, a timing module, and a first radio frequency signal module, the timing module and the first radio frequency signal module being connected to the processing module;
wherein the processing module is configured to receive the local time signal through the first radio frequency signal module and calibrate a current time of the timing module according to the local time signal so as to update the current time of the timing module.

6. The lighting system as claimed in claim 5, wherein the processing module is configured to receive the local time signal through the first radio frequency signal module and determine whether a difference between the local time signal and the current time of the timing module is within a calibration delay window, and wherein the processing module is configured to delay a calibration of the current time of the timing module according to a preset delay time when the difference between the local time signal and the current time of the timing module is within the calibration delay window.

7. The lighting system as claimed in claim 6, wherein the processing module is configured to calibrate the current time of the timing module when the difference between the local time signal and the current time of the timing module is higher than an upper limit of the calibration delay window, and wherein the processing module is configured not to calibrate the current time of the timing module when the difference between the local time signal and the current time of the timing module is lower than a lower limit of the calibration delay window.

8. The lighting system as claimed in claim 5, wherein the lighting device further comprises a light-emitting module connected to the processing module, and wherein the processing module is configured to receive a lighting configuration signal through the first radio frequency signal module and control the light-emitting module according to the lighting configuration signal.

9. The lighting system as claimed in claim 8, wherein the information publishing device comprises a global positioning module, a control module, and a second radio frequency signal module, wherein the global positioning module and the second radio frequency signal module are connected to the control module, wherein the global positioning module is configured to receive a global positioning signal, and the control module is configured to generate the local time signal according to the global positioning signal and transmit the local time signal to the first radio frequency signal module through the second radio frequency signal module.

10. The lighting system as claimed in claim 9, wherein the information publishing device further comprises a communication module connected to the control module, and wherein the control module is configured to receive the lighting configuration signal through the communication module and transmit the lighting configuration signal to the first radio frequency signal module.
